(19) United States
(12) Patent Application Publication
(10) Pub. No.: US 2014/0310130 A1
(43) Pub. Date: Oct. 16, 2014

(54) TRACKING WISH LIST

(71) Applicant: Suresh Kumar Bhat, Saratoga, CA (US)

(72) Inventor: Suresh Kumar Bhat, Saratoga, CA (US)

(21) Appl. No.: 13/860,655

(22) Filed: Apr. 11, 2013

(51) Int. Cl. G06Q 30/06

(52) U.S. Cl. CPC G06Q 30/0627
USPC 705/26.63; 705/14.73

(57) ABSTRACT

Information about a product, including a wished for price, is received from a user over the Internet. The wished for price is lower than a currently available price for the product. Manufacturers and sellers are investigated to obtain the wished for price. The user is notified when it is discovered that the product at the wished for price has become available for purchase.

### BACKGROUND

For ecommerce to be successful, there not only needs to be willing buyers and willing sellers, but the buyers and sellers have to locate each other. Sellers often spend a significant amount of money to identify prospective customers. Buyers can spend a significant amount of time to locate a merchant that will sell a desired product at a desired price. The inefficiency in the process can be a detriment to maximizing the benefit to the buyer and the seller.

### BRIEF DESCRIPTION OF THE DRAWINGS

FIG. 1 is a simplified block diagram of an ecommerce system in accordance with an embodiment.

FIG. 2 is a simplified flow chart of an ecommerce system in accordance with an embodiment.

FIG. 3, FIG. 4, FIG. 5 and FIG. 6 are simplified diagrams illustrating a user interface to an ecommerce system in accordance with an embodiment.

FIG. 7 is a simplified flow chart of interaction of a registered user with an ecommerce system in accordance with an embodiment.

FIG. 8 is a simplified flow chart of interaction of a non-registered user with an ecommerce system in accordance with an embodiment.

FIG. 9 is a simplified flow chart of interaction of a not logged in registered user with an ecommerce system in accordance with an embodiment.

FIG. 10, FIG. 11, FIG. 12 and FIG. 13 are simplified diagrams additionally illustrating a user interface to an ecommerce system in accordance with an embodiment.

### DESCRIPTION OF THE EMBODIMENT

An ecommerce system is provided that aids transactions between buyers and sellers. The ecommerce system has an option by which potential buyers can specify a price wish that is saved and monitored. A potential buyer is herein referred to generically as a customer. A customer is a potential buyer, an actual buyer, or merely one investigating a purchase. When a customer specifies a price wish, the ecommerce system queries or otherwise investigates manufacturers and sellers to see if they can match the wished for price specified by the customer. If the price is accepted, a response from a willing seller is saved and a notification—for example by an e-mail or text message—is sent to the customer indicating that a seller willing to sell at the wished for price has been found. The customer can log in to the ecommerce system and make the purchase. For example, the ecommerce system also has option to host advertisements from manufacturers and retailers that customers can refer to for product understanding and evaluation.

The ecommerce system also has an option by which customers can specify a particular retailer from which it is desired to purchase a wished for product or service. Once the particular retailer has the particular item available, a notification—for example by an e-mail or text message—is sent to the customer indicated that the particular seller has inventory of the wished for product or service. The customer can log in to the ecommerce system and make the purchase. Similarly the store availability wish will monitor the desired store for the inventory. Once inventory is available, an email notification to request customer to log into his account will be generated. The customer can log in to the ecommerce system and make the purchase, or based on the information provided by the ecommerce system make the purchase in another manner.

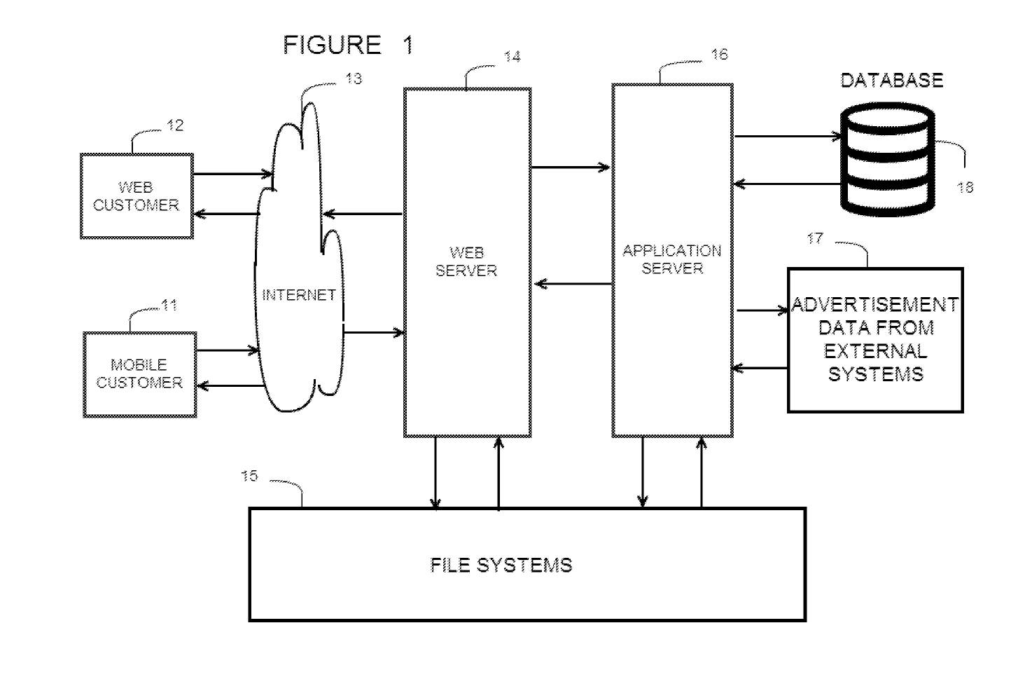

FIG. 1 shows an overview of the e-commerce system. A customer using, for example, a computer 12 or a mobile device 11 interacts with a web server 14 through the Internet 13. The ecommerce system resides on an application server 16 that, together with web server 14, has access to a file system 15. The ecommerce system accesses a database 18 and advertisement data from external systems.

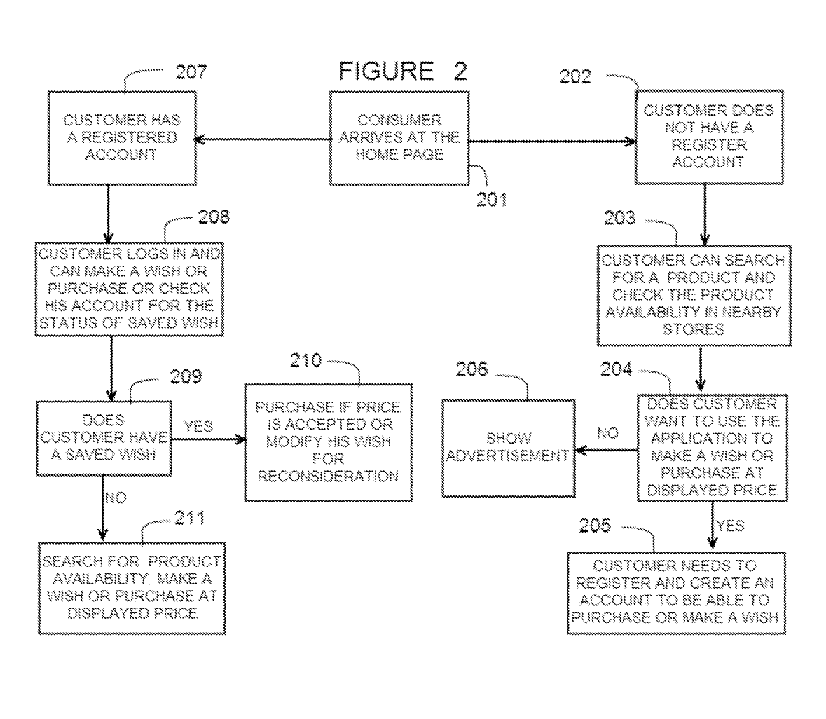

FIG. 2 is a simplified flowchart that illustrates operation of the ecommerce system. In a block 201, a customer (e.g., potential buyer) arrives at a home page for the ecommerce system. As illustrated by a block 202, if the customer does not have a registered account, in a block 203, the customer can search for product or service and check if the product or service is available at a nearby retail outlet.

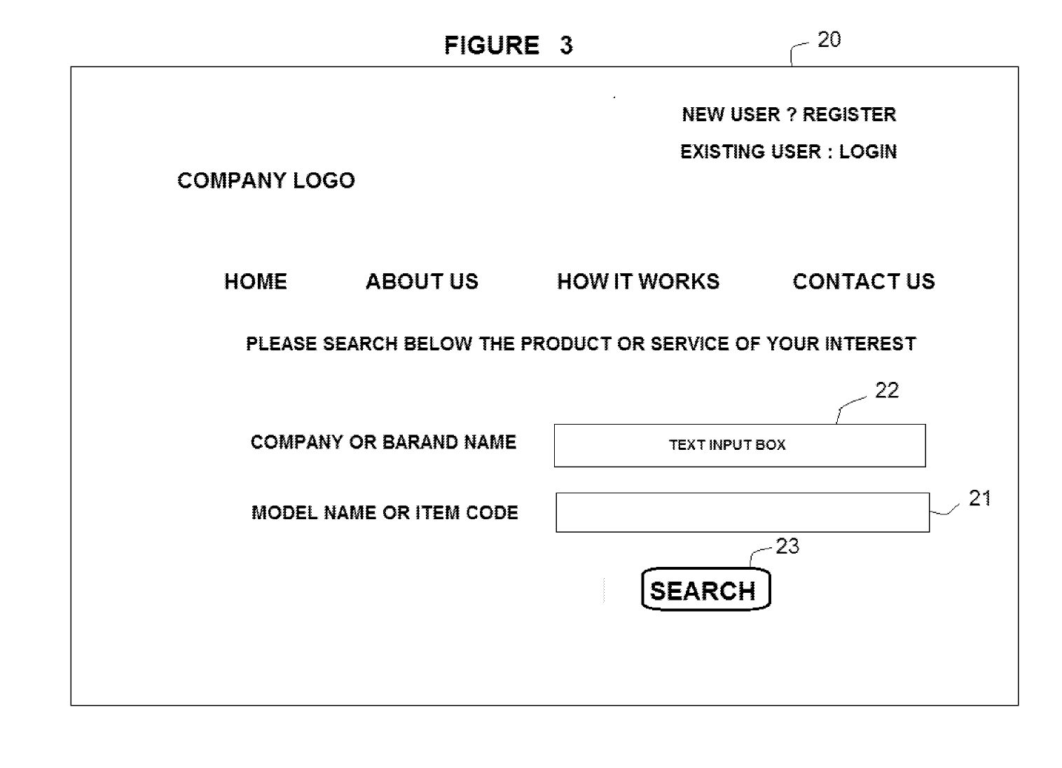

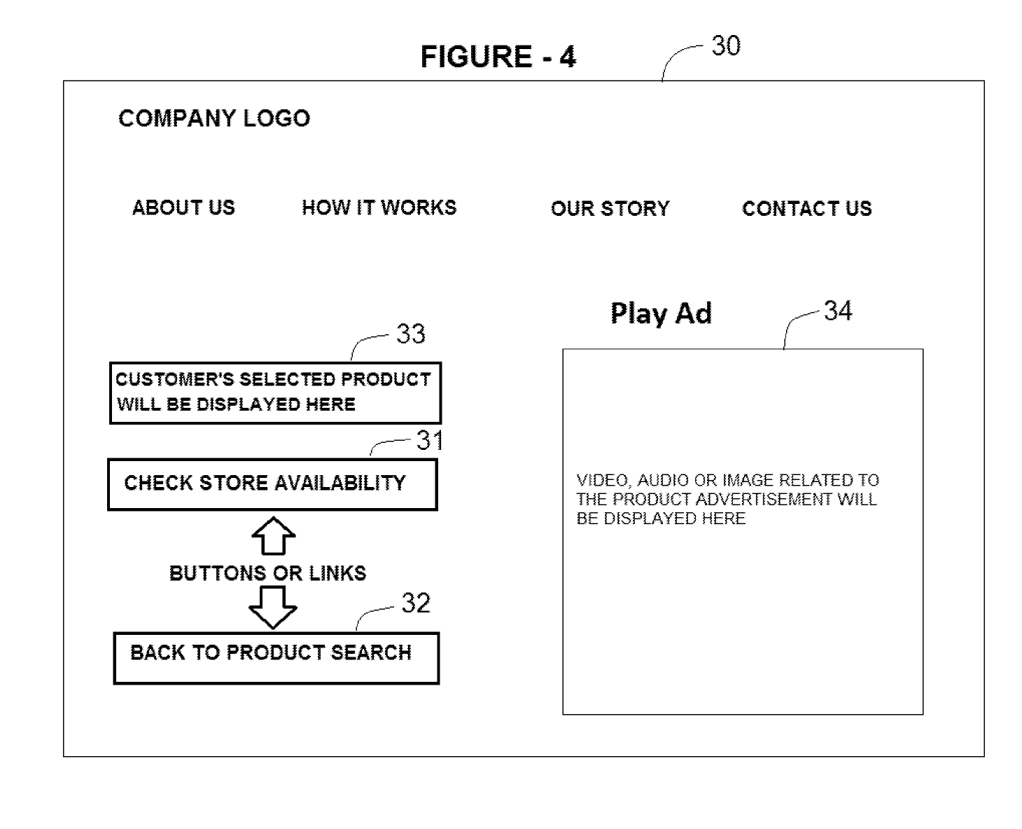

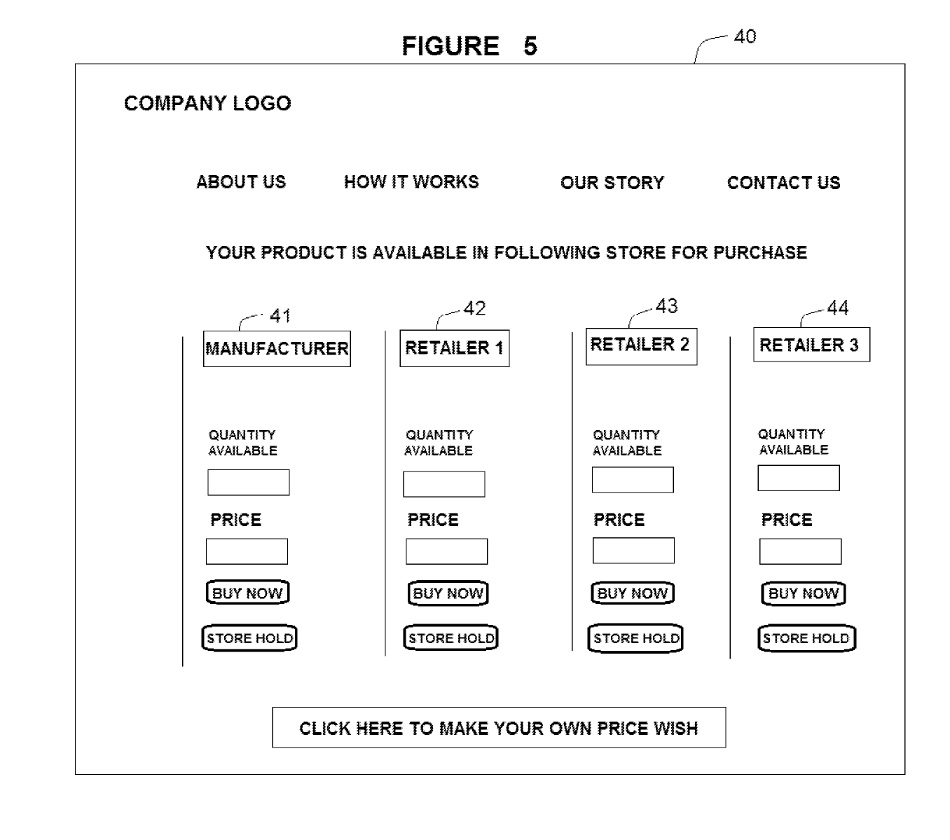

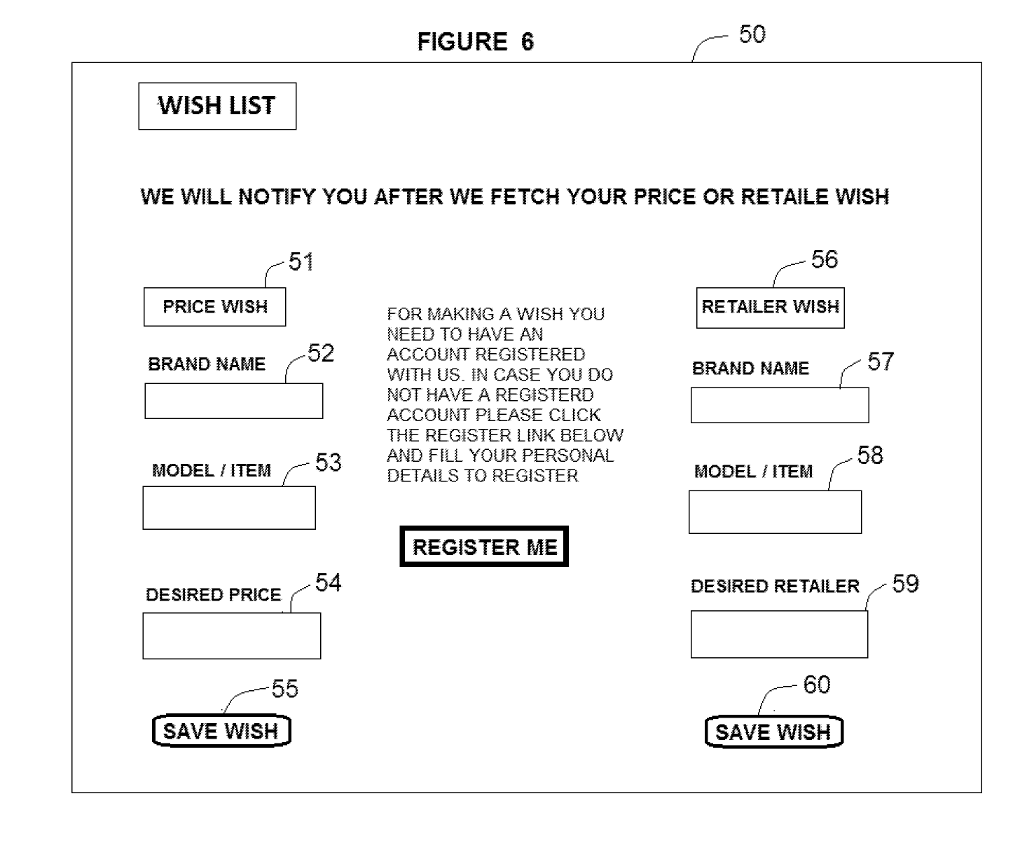

For example, FIG. 3 shows a window 20 displayed to the customer. The customer can use input boxes 21 and 22 to provide input about a product or service. For example, the customer can search for the product based on the brand and the product code or name. Once the customer inputs the values and hits a search button 23, the ecommerce system returns the list of products falling under the search category. Once the customer clicks on any of listed products, the customer is taken to the product page that displays the advertisement for the product as shown in FIG. 4. The ad may be video that manufacturer created for advertising on TV or it may be an audio clip if the brand owner advertised over radio. The customer will also be provided with a button to click for checking the availability of the product with different retailers and a back button option to take customer to previous page and choose another product from the search results or refine the search. For example, FIG. 4 shows a window 30 displayed to the customer. Information about a product or service is displayed in an area 33.

The customer can use button or link 31 to check store availability. The customer can use button 32 to go back to a product search. An advertisement about a product or service is displayed in a display area 34. For example, an algorithm could be used to display any or all the advertisement campaigns for the product or service. For example, when only one advertisement is displayed, video advertisements will have highest priority, audio advertisements will have second highest priority, print media advertisements will have lowest priority. For example, any advertisement may include display of an image of a product, a service provider's logo, or another image identified with a product, a service or a provider.

In a block 204 (shown in FIG. 2), the customer is queried to determine if the customer desires to purchase the product or service at a displayed price, or if the customer desires to specify a wished for price at which the customer would like to purchase the product or service.

If the customer does desire to purchase the product or service at a displayed price, or if the customer desires to specify a wished for price at which the customer would like to purchase the product or service, in a block 205, the customer will be directed to register and create an account with the ecommerce service. See for example the registration page shown in FIG. 12. This will allow the customer to use the ecommerce system to purchase the product or service at the displayed price, or to specify a wished for price at which the customer would like to purchase the product or service. If the customer does not desire to purchase the product or service at a displayed price and does not desire to specify a wished for price at which the customer would like to purchase the product or service, in a block 206, an advertisement for the product or service is displayed to the customer. This is done, for example, by returning the customer to window 30, shown in FIG. 4.

From block 201, as illustrated by a block 207, if the customer has a registered account, in a block 208, the customer can log in and can search for a product or a service and check if the product or service is available at a nearby retail outlet. In addition, the customer can purchase the product or service at a displayed price, or the customer can specify a wished for price at which the customer would like to purchase the product or service. The customer can also check the status of any saved wished for price at which the customer would like to purchase a product or service.

For example, in a block 209, a check is made as to whether the customer has a saved wished for price at which the customer would like to purchase a product or service. If the customer has a saved wished for price at which the customer would like to purchase a product or service, then in a block 210, the customer can check if the wished for price has been met. If so, the customer can purchase the product or service. Also, the customer has the opportunity to modify the wished for price, for example by increasing or decreasing the wished for price. The customer can also cancel the wished for price.

If in block 209 the customer does not have a saved wished for price at which the customer would like to purchase a product or service, in a block 211, the customer can search for a product or service, check if the product or service is available at a nearby retail outlet, and if desired, record a wished for price at which the customer would like to purchase the product or service.

For example, if a customer selects check store availability link 31 of window 30, shown in FIG. 4, and has already registered account with the ecommerce system, the customer is provided with the information about three stores selling the product at a lowest, a second lowest and a third lowest price. For example, original manufacturer's suggested retail price is also displayed for comparison purpose.

For example, FIG. 5 shows a window 40 displayed to the customer. Window 40 includes a column 41 for information from a manufacturer, a column 42 for information from a lowest priced retailer, a column 43 for information from a second lowest priced retailer, and a column 44 for information from a third lowest priced retailer.

The customer is given an option to buy from any of the listed retailers online. For example, the customer is also informed about the quantity available with retailers selling at lowest price. For example, if the customer is not yet a registered user, the customer is prompted to register to see the lowest product price available in stores near the customer's current location and to see the quantity of the product available in these stores. For example, the ecommerce system also has an option for the customer to put a hold on the product in the nearest store if the customer wants to go and pick up the product or service from the store instead of placing an order online. This will ensure the product is available for the customer to purchase when the customer arrives at the store.

As discussed above, the ecommerce system allows customers to specify a price wish that is saved and monitored. For example, a wished for price is stored and potential seller are queried for a price match. For example, the ecommerce system also runs an extensive Internet search using arguments such as brand name, item code, inventory more than zero and maximum price. When a retailer with a price match is found, the ecommerce system notifies the customer, for example through email or a text message according to preferences set by the customer, as illustrated in FIG. 13, that the wished for price has been granted. Upon receiving the notification, the customer can log into the pertinent ecommerce system account and make the purchase.

As also discussed above, the ecommerce system allows customers to specify a particular retailer from which the customer desires to purchase a wished for product or service. For example, the ecommerce system searches the Internet and the know retailer sites using arguments such as brand name, item code retailer name and inventory more than zero. A customer may choose this option, for example, if the customer has a user account with the retailer and gets discount on the purchase or loyalty points, etc.

For example, FIG. 6 shows a wish list page 50 presented by the ecommerce system to the customer. A price wish column 51 allows a user to enter brand name in a box 52, model or item information in a box 53 and a desired price in a box 54. Selection of a save wish button 55 results in the price wish being saved. A retailer wish column 56 allows a user to enter brand name in a box 57, model or item information in a box 58 and a desired retailer in a box 59. Selection of a save wish button 60 results in the retailer wish being saved.

For example the ecommerce system can base a product search on an advertisement of a product or service. For example, the advertisement could be a commercial on television, the radio or a page on the world wide web. In addition, manufactures can arrange to publish advertisements or services directly on the ecommerce system web site. The ecommerce system can store advertisement, for example, in database 18 shown in FIG. 1, and can search for advertisements over Internet 13.

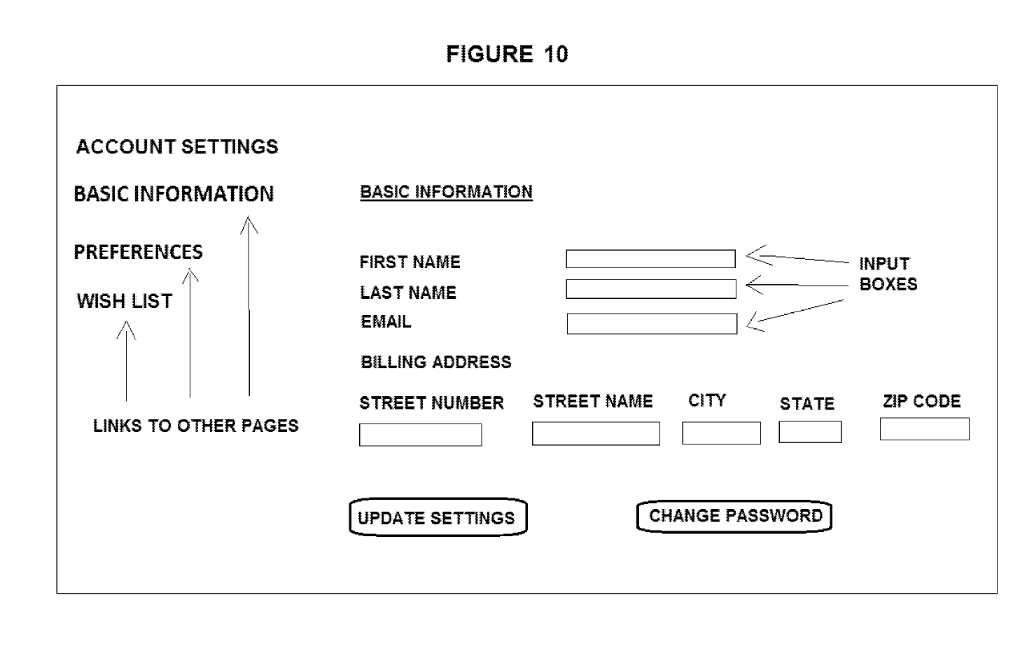

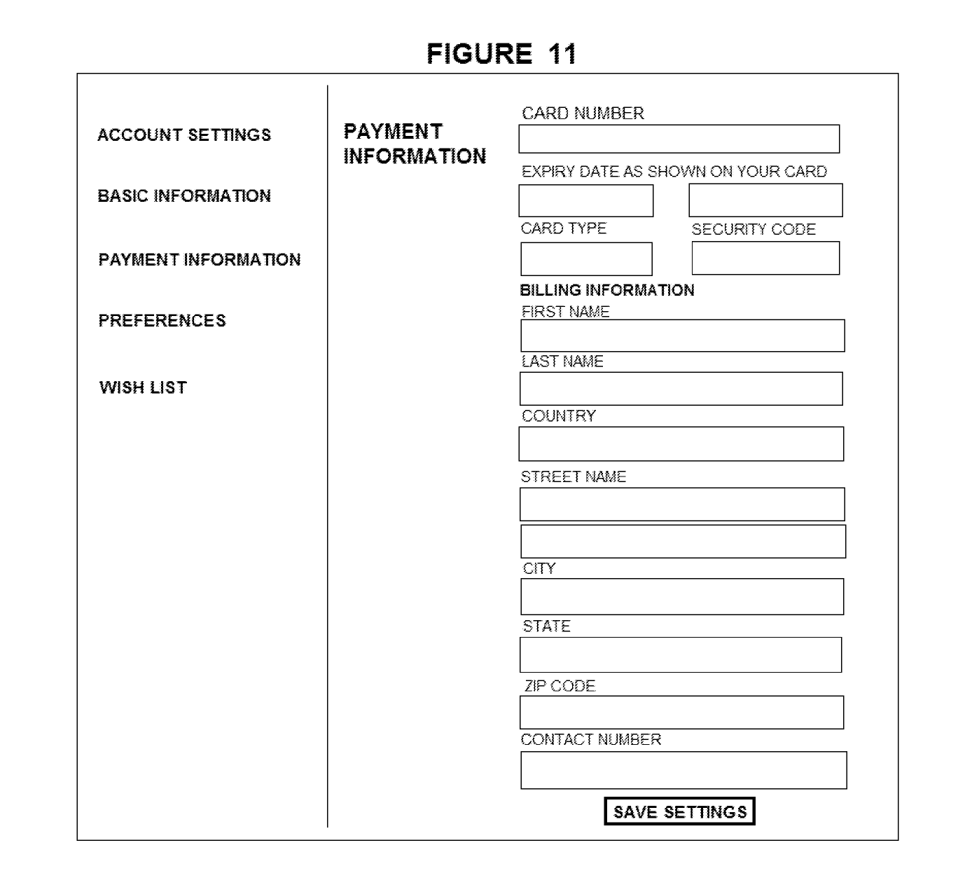

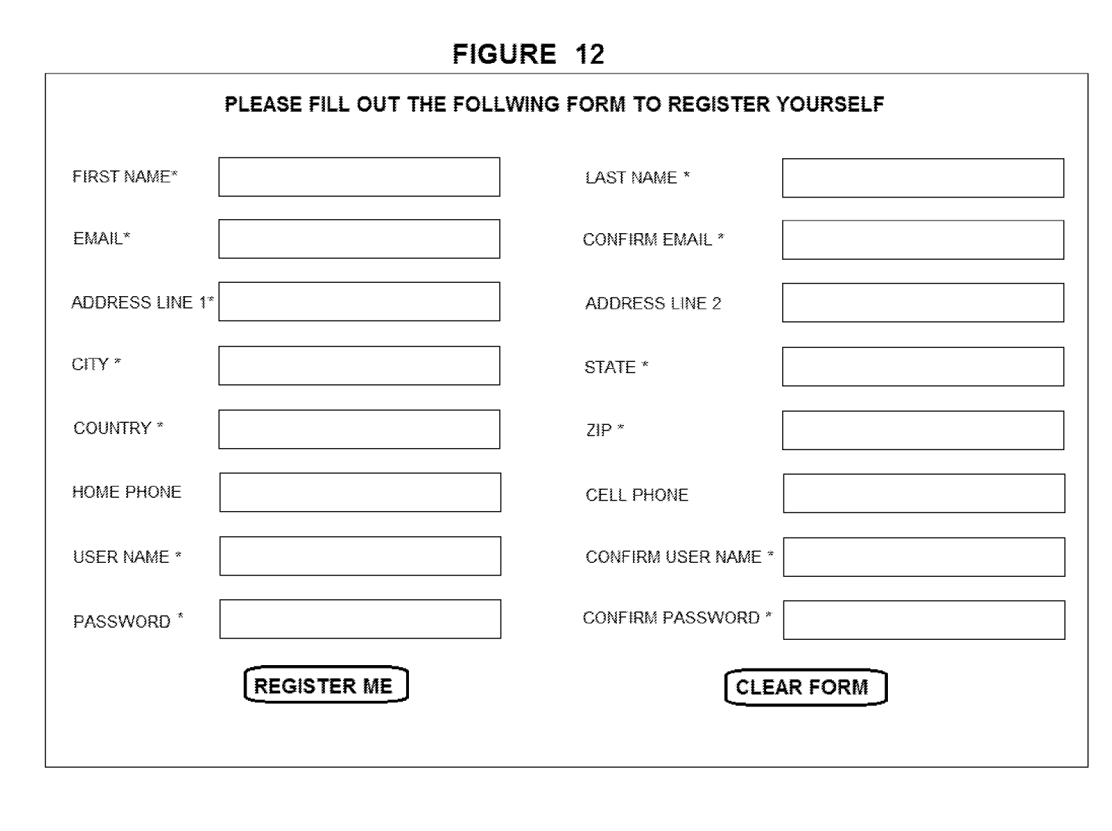

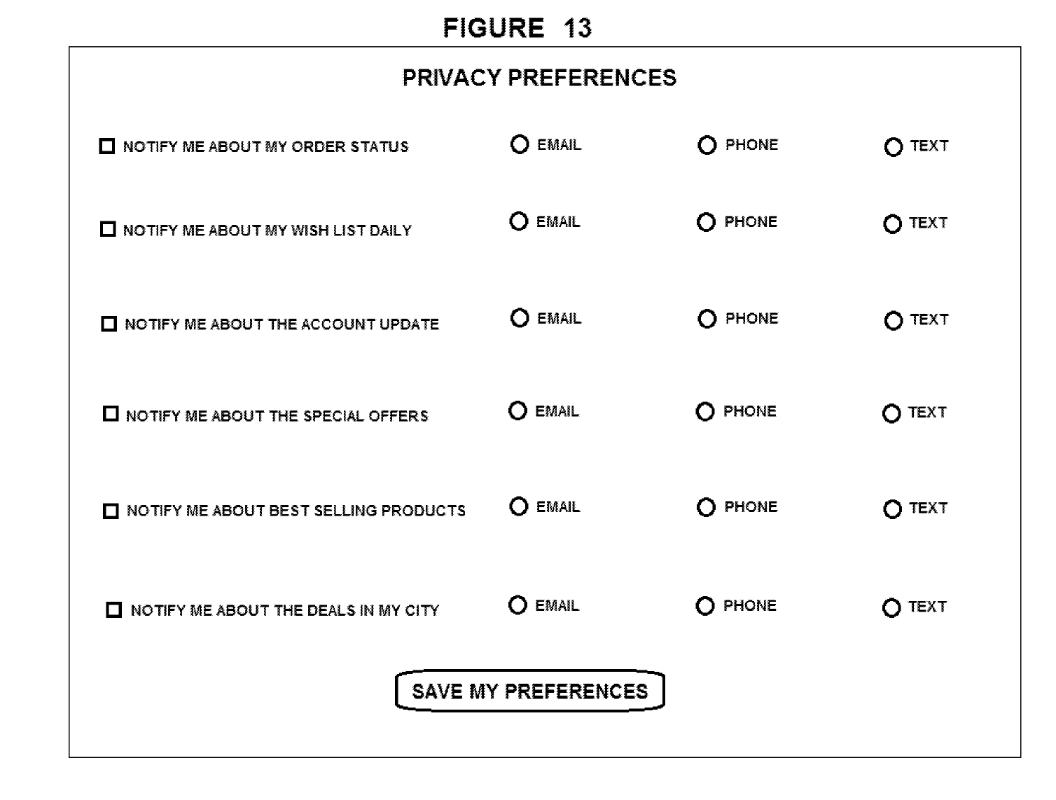

For example, the ecommerce system uses a customer account settings page as shown in FIG. 10 to determine retailer locations near the customers. For example, a zip code saved by the customer is used to identify retailer locations in a radius of predetermined distance with a lowest price. The customer can modify contact details allowing the customer to find the retailers in any desired area. For example, the customer can modify address when the customer is located in a different area. Customer account settings also include, for example, a link to privacy information, a button to change password information, an option to change contact information and a button to update settings. The customer account settings also includes, for example, a link to a wish list page to simplify customer access to saved wishes.

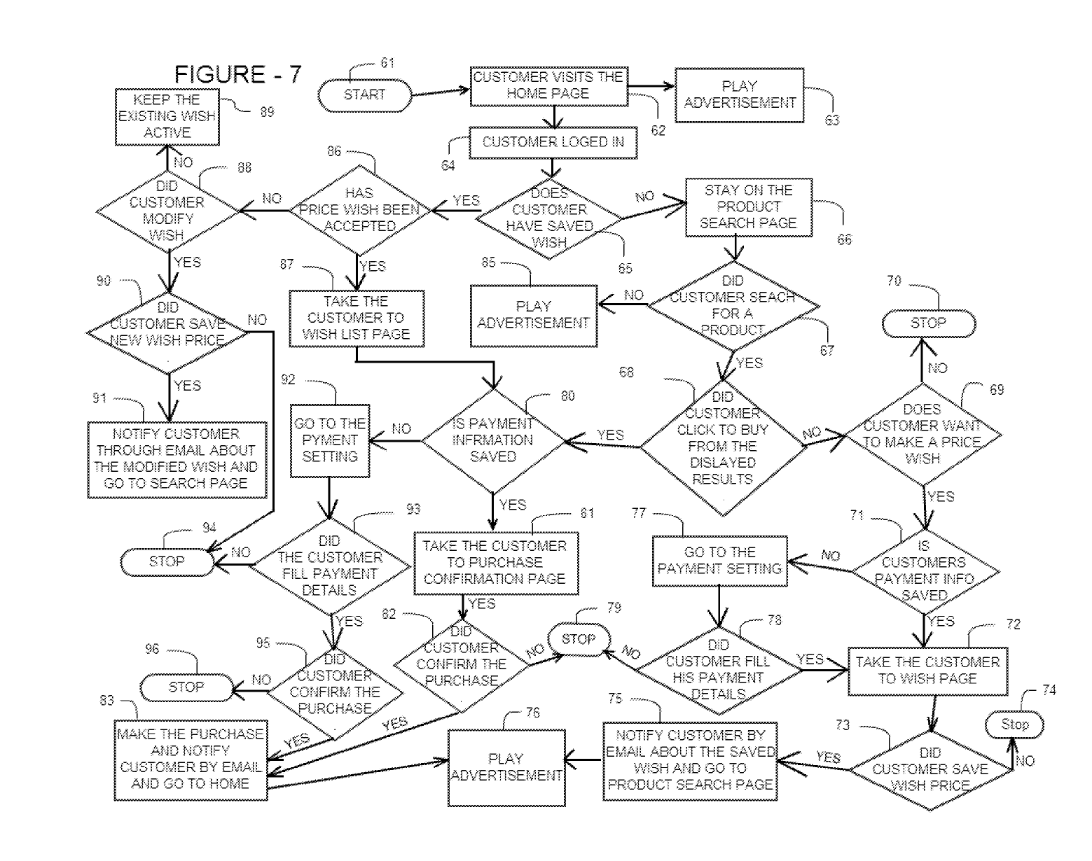

FIG. 7 is a simplified flow chart illustrating interaction of a customer, who is a registered user, with the ecommerce system. After a start block 61, in a block 62, a customer visits a home page for the ecommerce system. In a block 63 an advertisement is played. In a block 64, a customer logs in. In a block 65, a determination is made as to whether the customer has a saved wish. In not, in a block 66, the ecommerce system stays on a product search page as illustrated in FIG. 3. In a block 67, it is determined whether a customer searched for a product. If not, in a block 85, an advertisement is played.

If in block 67, it is determined that the customer searched for a product, in a block 68 a determination is made as to whether the customer clicked to buy from the displayed results. If not, in a block 69, a determination is made as to whether the customer wants to make a price wish. If not, a stop block 70 is reached.

If in block 69 it is determined that the customer wants to make a price wish, in a block 71 it is determined whether the customer's payment information is saved. If so, in a block 72 the customer is taken to a wish page, as illustrated in FIG. 6. In a block 73 a determination is made as to whether the customer saved a wish price. If not, a stop block 74 is reached.

If in block 73 it is determined that the customer saved a wish price, in a block 75, the customer is notified by e-mail concerning the saved wish. The customer is returned to the product search page shown in FIG. 3. Also, in a block 76, an advertisement is displayed.

If in block 71 it is determined that the customer's payment information is not saved, in a block 77, the customer is sent to a web page that receives payment details from the customer, as illustrated in FIG. 11. In a block 78 a determination is made as to whether the customer filled in payment details, as shown in FIG. 11. If not, a stop block 79 is reached. If in block 78 it is determined that the customer has filled in payment details, in block 72 the customer is taken to a wish page, as illustrated in FIG. 6.

If in block 68 it is determined that the customer clicked to buy from the displayed results, in a block 80 it is determined whether the customer's payment information is saved. If so, in a block 81 the customer is taken to a purchase confirmation page. In a block 82 a determination is made as to whether the customer confirmed the purchase. If not, stop block 79 is reached.

If in block 82 it is determined that the customer confirmed the purchase, in a block 83 the purchase is made and the customer is notified by e-mail. The customer is also returned to a home page of the ecommerce system. In a block 76, an advertisement is played.

If in block 80 it is determined that payment information is not saved, in a block 92, the customer is taken to the web page that receives payment details from the customer, as illustrated in FIG. 11. In a block 93 a determination is made as to whether the customer filled in payment details. If not, a stop block 94 is reached. If in block 93 it is determined that the customer has filled in payment details, in a block 95 a determination is made as to whether the customer confirmed the purchase. If not, a stop block 96 is reached.

If in block 95 it is determined that the customer confirmed the purchase, in block 83 the purchase is made and the customer is notified by e-mail. The customer is also returned to a home page of the ecommerce system. In block 76, an advertisement is played.

If in block 65, it is determined that the customer has saved a wish, in a block 86, it is determined whether the wish has been accepted. If so, in a block 87, the customer is taken to a wish list page showing a list of made wishes. Then, in block 80 it is determined whether the customer's payment information is saved, and so on.

If in block 86, it is determined that the wish has not been accepted, in a block 88 it is determined whether the customer modified the wish. If not, in a block 89 the existing wish is kept active. If in block 88 it is determined that the customer has modified the wish, in a block 90 it is determined whether the customer saved a new wish price. If so, in a block 91 the customer is notified through e-mail about the modified wish. The customer is then returned to the search page illustrated in FIG. 3. If in block 90 it is determined that the customer did not save a new wish price, stop block 94 is reached.

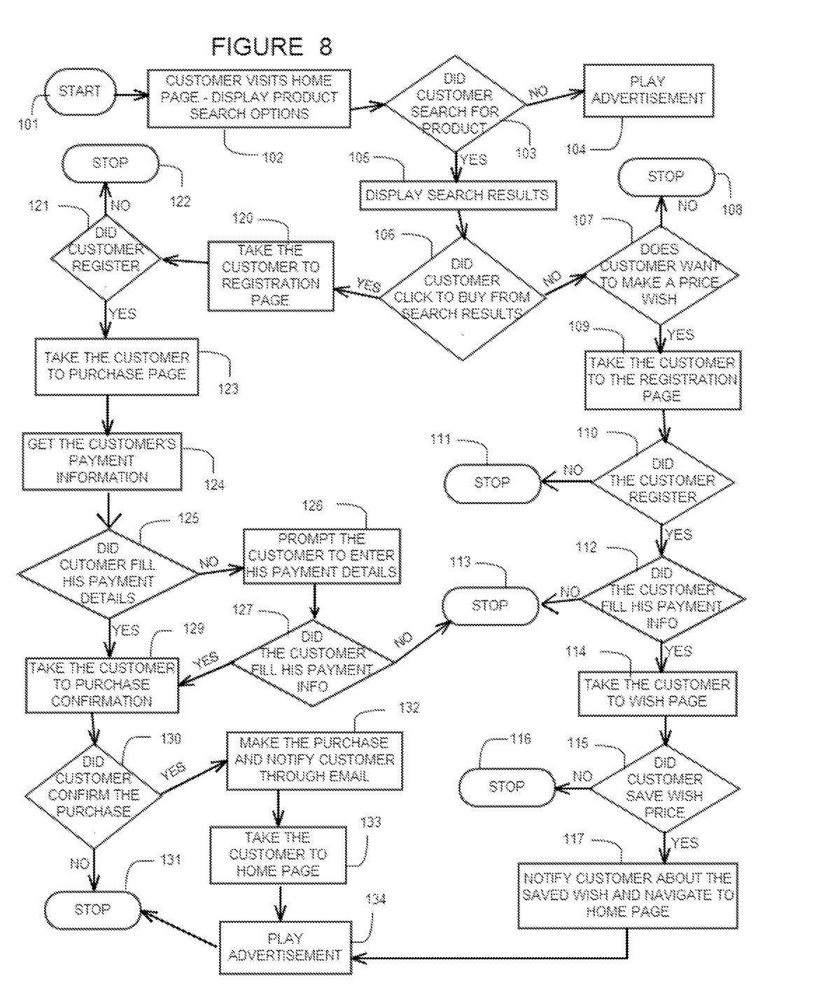

FIG. 8 is a simplified flow chart of interaction of a non-registered user with an ecommerce system. After a start block 101, in a block 102, a customer visits a home page for the ecommerce system. In a block 103, it is determined whether a customer searched for a product. If not, in a block 104, an advertisement is played.

If in block 103, it is determined that the customer searched for a product, in a block 105 search results are displayed, as illustrated by FIG. 5. In a block 106 a determination is made as to whether the customer clicked to buy from the displayed results. If not, in a block 107, a determination is made as to whether the customer wants to make a price wish. If not, a stop block 108 is reached.

If in block 107, it is determined that the customer wants to make a price wish, in a block 109 the customer is taken to a registration page. In a block 110, it is determined whether the customer registered. If not, a stop block 111 is reached.

If in block 110, it is determined that the customer registered, in a block 112 it is determined whether the customer filled in payment information. If not, a stop block 113 is reached.

If in block 112 it is determined that the customer's payment information is saved, in a block 114 the customer is taken to a wish page, as illustrated in FIG. 6. In a block 114 a determination is made as to whether the customer saved a wish price. If not, a stop block 116 is reached.

If in block 115 it is determined that the customer saved a wish price, in a block 117, the customer is notified by e-mail concerning the saved wish. The customer is returned to a home page of the ecommerce system. In a block 118 an advertisement is displayed. Then a stop block 119 is reached.

If in block 106, the customer did click to buy from search results, in a block 120 the customer is taken to the registration page. In a block 121, it is determined whether the customer registered. If not, a stop block 122 is reached.

If in block 121, it is determined that the customer registered, in a block 123, the customer is taken to a purchase page. In a block 124, the customer's payment information is received. In a block 125 it is determined whether the customer's payment information has been filled in. If so, in a block 129 the customer is taken to a purchase confirmation page. In a block 130 a determination is made as to whether the customer confirmed the purchase. If not, a stop block 131 is reached.

If in block 130 it is determined that the customer confirmed the purchase, in a block 132 the purchase is made and the customer is notified by e-mail. In a block 133, the customer is also returned to a home page of the ecommerce system. In a block 134, an advertisement is played and a stop block 135 is reached.

If in block 125 it is determined that payment information is not saved, in a block 126, the customer is prompted to enter payment details. In a block 127 a determination is made as to whether the customer filled in payment details. If not, a stop block 128 is reached. If in block 127 it is determined that the customer has filled in payment details, in block 129 the customer is taken to a payment confirmation page and so on.

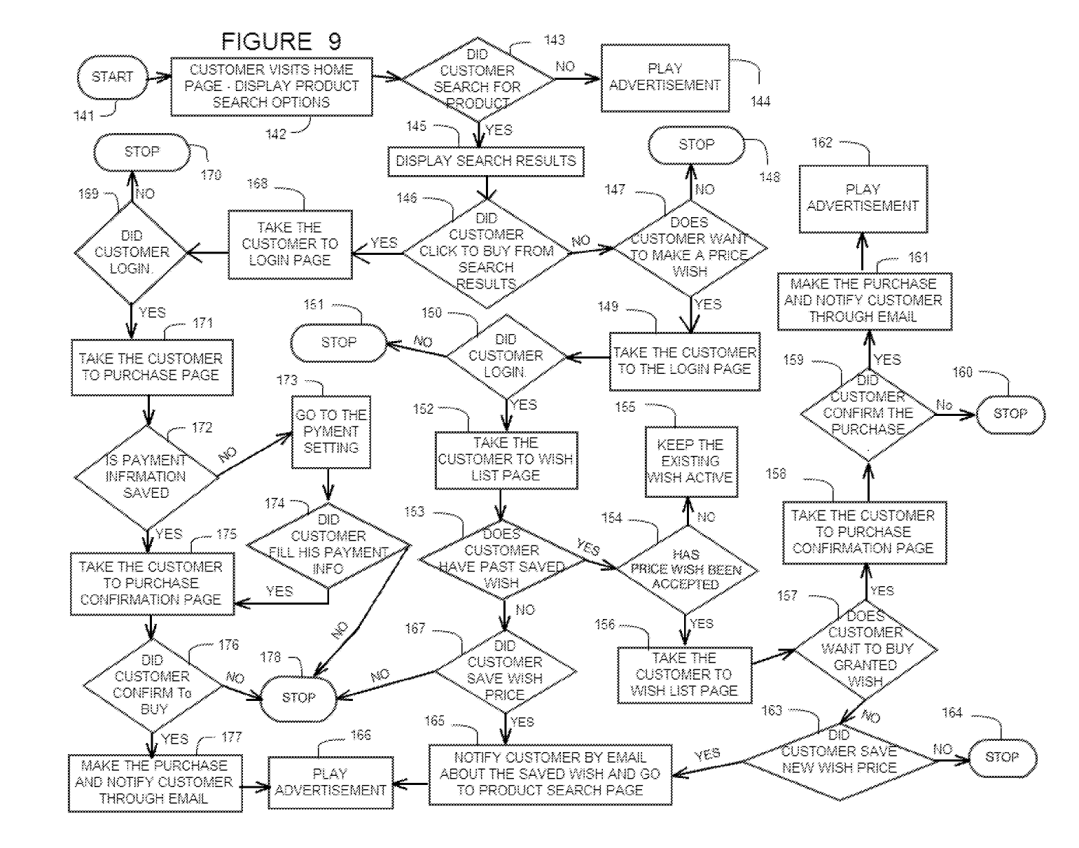

FIG. 9 is a simplified flow chart of interaction of a not logged in registered user with an ecommerce system. After a start block 141, in a block 142, a customer visits a home page for the ecommerce system. The home page displays product search options. In a block 143, it is determined whether a customer searched for a product. If not, in a block 144, an advertisement is played.

If in block 143, it is determined that the customer searched for a product, in a block 145 search results are displayed, as illustrated by FIG. 5. In a block 146 a determination is made as to whether the customer clicked to buy from the displayed search results. If not, in a block 147, a determination is made as to whether the customer wants to make a price wish. If not, a stop block 148 is reached.

If in block 147, it is determined that the customer wants to make a price wish, in a block 149 the customer is taken to a login page. In a block 150, a determination is made as to whether the customer did login. If not, a stop block 151 is reached.

If in block 150, it is determined that the customer did login, in a block 152 the customer is taken to a wish page. In a block 153 a determination is made as to whether the customer has an existing saved wish price. If so, in block 154 it is determined whether the price wish was accepted. If not, in a block 155, the existing wish is kept active.

If in block 154 it is determined that the price wish was accepted, in a block 156 the customer is take to a wish list page showing a list of made wishes. In a block 157, it is determined whether the customer wants to purchase the item for which the wish was granted. If so, in a block 158 the customer is taken to a purchase confirmation page. In a block 159 a determination is made as to whether the customer confirmed the purchase. If not, a stop block 160 is reached.

If in block 159 it is determined that the customer confirmed the purchase, in a block 161 the purchase is made and the customer is notified by e-mail. In a block 162, an advertisement is played.

If in block 157 it is determined that the customer does not want to buy a granted wish, but wants to make a new wish, in a block 163 it is determined whether the customer saved a new wish price. If not, a stop block 164 is reached. If in block 163 it is determined that the customer saved a new wish price, in a block 165 the customer is notified through e-mail about the saved wish. The customer is then returned to the search page illustrated in FIG. 3. In a block 166, an advertisement is played.

If in block 146 it is determined that the customer clicked to buy from the displayed results, in a block 168 the customer is taken to a login page. In a block 169, a determination is made as to whether the customer did login. If not, a stop block 170 is reached.

If in block 169, it is determined that the customer did login, in a block 171 the customer is taken to the purchase payment page. In a block 172 it is determined whether payment information is saved. If not, in a block 173 the customer is taken to a payment settings page. In a block 174, it is determined whether the customer filled in payment information. In not, stop block 151 is reached.

If in block 174 it is determined that payment information has been filled in, in a block 175 the customer is take to a purchase confirmation page. In block 176, it is confirmed that the customer confirmed the purchase. When the customer confirms the purchase, in a block 177, the purchase is made and the customer is notified through e-mail. In block 166, an advertisement is played.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

1. A computer implemented method comprising:
receiving from a user over the internet by a server, information about a product;
searching the Internet for lowest cost providers of the product;
displaying information to the user about the lowest cost providers;
receiving from the user a wished for price, the wished for price being lower than a currently available price for the product from the lowest cost providers;
investigating manufacturers and sellers to obtain the wished for price; and, notifying the user when it is discovered that the product at the wished for price becomes available for purchase.

2. A computer implemented method as in claim 1 additionally comprising:
receiving from the user a wished for retailer;
monitoring information available on the Internet pertaining to the retailer; and,
notifying the user when it is discovered that the product is available for purchase at the wished for retailer.

3. A computer implemented method as in claim 1 wherein the information about the product includes brand name and model number or item name.

4. A computer implemented method as in claim 1 additionally comprising:
receiving a user location;
monitoring information available on the Internet pertaining to retailers located within a predetermined radius from the user and having lowest price and availability for the product; and,
displaying to the user information about lowest selling retailers available within the predetermined radius.

5. A computer implemented method as in claim 1 additionally comprising:
monitoring information available on the Internet pertaining to the product.

6. An ecommerce system that comprises:
a server connected to the Internet;
an ecommerce module, within the server, that produces a graphical user interface for display on a user device, the user device being connected through the Internet to the server, the graphical user display receiving, from a user, information about a product including a wished for price, the ecommerce module investigating manufacturers and sellers to obtain the wished for price, the ecommerce module notifying the user when the ecommerce module discovers that the product at the wished for price becomes available for purchase.

7. An ecommerce system as in claim 6 wherein the graphical user display also receives from the user a wished for retailer, the ecommerce module monitoring information available on the Internet pertaining to the retailer, ecommerce module notifying the user when the ecommerce module discovers that the product is available for purchase at the wished for retailer.

8. An ecommerce system as in claim 6 wherein the information about the product includes brand name and model number or item name.

9. An ecommerce system as in claim 6 wherein the ecommerce module receives a user location, monitors information available on the Internet pertaining to retailers located within a predetermined radius from the user and having lowest price and availability for the product and displays to the user information about lowest selling retailers available within the predetermined radius.

10. An ecommerce system as in claim 6 wherein the ecommerce module plays advertisements on demand.

11. A computer implemented method comprising:
receiving from a user over the internet by a server, information about a product including a wished for price, the wished for price being lower than a currently available price for the product;
investigating manufacturers and sellers to obtain the wished for price; and,
notifying the user when it is discovered that the product at the wished for price becomes available for purchase.

12. A computer implemented method as in claim 11 additionally comprising:
receiving from the user a wished for retailer;
monitoring information available on the Internet pertaining to the retailer; and,
notifying the user when it is discovered that the product is available for purchase at the wished for retailer.

13. A computer implemented method as in claim 11 wherein the information about the product includes brand name and model number or item name.

14. A computer implemented method as in claim 11 additionally comprising:
receiving a user location;
monitoring information available on the Internet pertaining to retailers located within a predetermined radius from the user and having lowest price and availability for the product; and,
displaying to the user information about lowest selling retailers available within the predetermined radius.

15. A computer implemented method as in claim 11 additionally comprising:
monitoring information available on the Internet pertaining to the product.

16. A computer implemented method as in claim 11 additionally comprising:
searching for advertisements for the product in a database or on the Internet.

17. A computer implemented method as in claim 11 additionally comprising:
displaying an advertisement for the product.
